(19) United States
(12) Patent Application Publication
(10) Pub. No.: US 2015/0070280 A1
(43) Pub. Date: Mar. 12, 2015

(54) ELECTRONIC DEVICE, METHOD AND STORAGE MEDIUM

(71) Applicant: Kabushiki Kaisha Toshiba, Tokyo (JP)

(72) Inventor: Tadashi Tsuji, Tachikawa-shi (JP)

(73) Assignee: Kabushiki Kaisha Toshiba, Tokyo (JP)

(21) Appl. No.: 14/290,394

(22) Filed: May 29, 2014

(30) Foreign Application Priority Data
Sep. 6, 2013 (JP) 2013-185379

(51) Int. Cl. G06F 3/02

(52) U.S. Cl. CPC G06F 3/0227
USPC 345/168

(57) ABSTRACT

According to one embodiment, an electronic device includes a port, an acquisition controller and a controller. The port is connectable to an extension unit with a keyboard. The acquisition controller is configured to acquire first information from the extension unit connected to the port. The controller is configured to control an operation of the device based on the first information acquired by the acquisition controller.

### CROSS-REFERENCE TO RELATED APPLICATIONS

This application is based upon and claims the benefit of priority from Japanese Patent Application No. 2013-185379, filed Sep. 6, 2013, the entire contents of which are incorporated herein by reference.

### FIELD

Embodiments described herein relate generally to a control technique suitable for, for example, portable electronic devices called, for example, tablets and powered by batteries.

### BACKGROUND

Although as portable electronic devices, personal computers of notebook type including a display and a keyboard formed integral as one body were prevailing so far, electronic devices called, for example, tablets, which includes a touch screen display and no keyboards, have recently rapidly become popular. Among these electronic devices, those which can be used in the same way as personal computers when they are connected to an extension unit with a keyboard are increasing.

Further, in accordance with the spread of portable electronic devices, a new method of utilization of electronic devices, called Bring Your Own Device (BYOD), where individually-owned electronic devices (including a case where a company gives a person the loan of an electronic device) are brought into offices and used for business, is also becoming popular. Under these circumstances, there is a demand for adaptively controlling electronic devices in accordance with various environments and situations (places) in which the devices are used.

However, at present, individual electronic devices called, for example, tablets cannot be adaptively controlled in environmental setting or functionality restriction in accordance with the situations, although environmental setting or functionality restriction can be made for each type of the electronic devices.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing an appearance of an electronic device according to an embodiment.

FIG. 2A is an exemplary view showing a first style of use (tablet style) of the electronic device according to the embodiment.

FIG. 2B is an exemplary view showing a second style of use (ultra-book style) of the electronic device according to the embodiment.

FIG. 3 is an exemplary view showing a state in which the electronic device of the embodiment is connected to a plurality of extension units.

FIG. 4 is an exemplary block diagram showing a system configuration of the electronic device of the embodiment.

FIG. 5 is an exemplary block diagram for explaining the basic principle of operation of the electronic device associated with the environmental setting and functionality restriction corresponding to situations.

FIG. 6 is an exemplary first flowchart showing a flow of operation of the electronic device associated with the environmental setting and functionality restriction corresponding to situations.

FIG. 7 is an exemplary second flowchart showing a flow of operation of the electronic device associated with the environmental setting and functionality restriction corresponding to situations.

### DETAILED DESCRIPTION

Various embodiments will be described hereinafter with reference to the accompanying drawings.

In general, according to one embodiment, an electronic device includes a port, an acquisition controller and a controller. The port is connectable to an extension unit with a keyboard. The acquisition controller is configured to acquire first information from the extension unit connected to the port. The controller is configured to control an operation of the device based on the first information acquired by the acquisition controller.

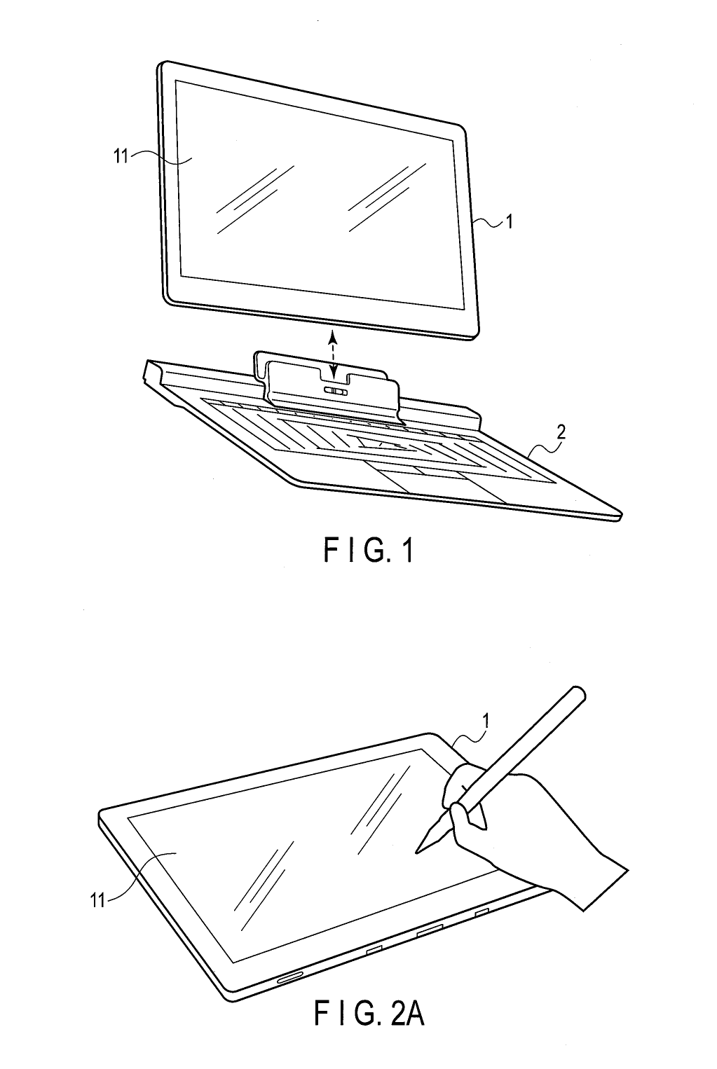

FIG. 1 is an exemplary perspective view showing an appearance of an electronic device according to the embodiment. This electronic device is, for example, a portable electronic device to which data can be input by handwriting using a pen or finger. In the description below, it is assumed that this electronic device is realized as a tablet computer 1.

As shown in FIG. 1, the tablet computer 1 includes a touch screen display 11. The touch screen display 11 is attached to the upper surface of the tablet combination 1, superposed thereon. The touch screen display 11 incorporates a flat panel display, and a sensor configured to detect a touch position of the pen or finger on the screen of the flat panel display. The flat panel display is, for example, a liquid crystal display (LCD). The sensor is, for example, an electrostatic capacitance type touch panel or an electromagnetic induction type digitizer. It is assumed that the touch screen display 11 incorporates two sensors, i.e., both the digitizer and the touch panel.

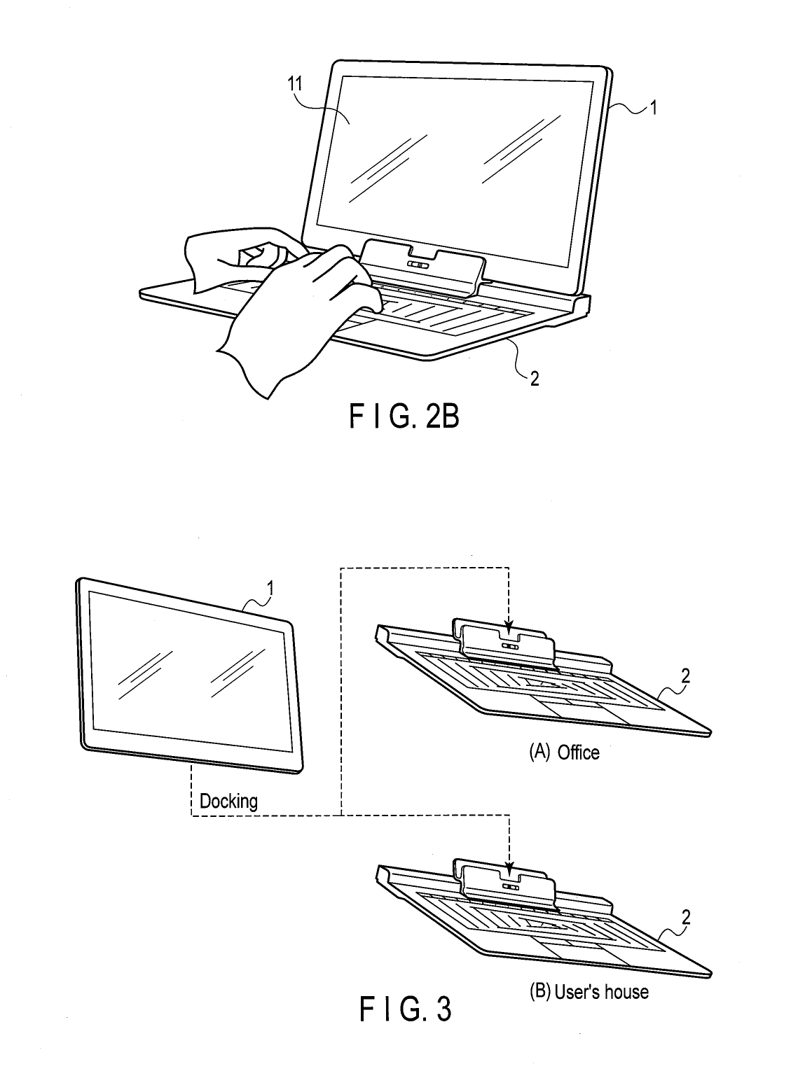

Further, as shown in FIG. 1, the tablet computer 1 is configured to be connected to an extension unit 2 with a keyboard, when necessary. In the description below, the extension unit 2 will be referred as a “keyboard dock 2”. Namely, the tablet computer 1 can be used in two ways, i.e., used singly (connected to no keyboard dock 2) as shown in FIG. 2A, and used connected to the keyboard dock 2 as shown in FIG. 2B. The state shown in FIG. 2A is called, for example, a tablet style, while the state shown in FIG. 2B is called, for example, an ultra-book style.

A user may carry a single keyboard dock 2 along with the tablet computer 1, or may use a plurality of keyboard docks 2 so that the tablet computer 1 is connected to different keyboard docks 2 in different places for ultra-book style use. From a different viewpoint, a single keyboard dock 2 can be shared by a plurality of users. For instance, as shown in FIG. 3, a company member may use a personally possessed tablet computer 1 in an office by connecting it to a keyboard dock 2 placed in the office, and use it in their house by connecting the same to another keyboard dock 2 placed therein. The use of a user's owned computer in an office is called, for example, Bring Your Own Device (BYOD).

For instance, when a company member uses their owned tablet computer 1 in both the office and their house, it is desirable from the view of security (for example, prevention of leakage of confidential information) that the environmental setting or functionality restriction of the tablet computer 1 be adaptively updated at the time of changing the place where the computer is used. In light of the fact that the keyboard dock 2 is configured to be attachable and detachable, the tablet computer 1 is made to adaptively perform environmental setting and functionality restriction. This will now be described in detail.

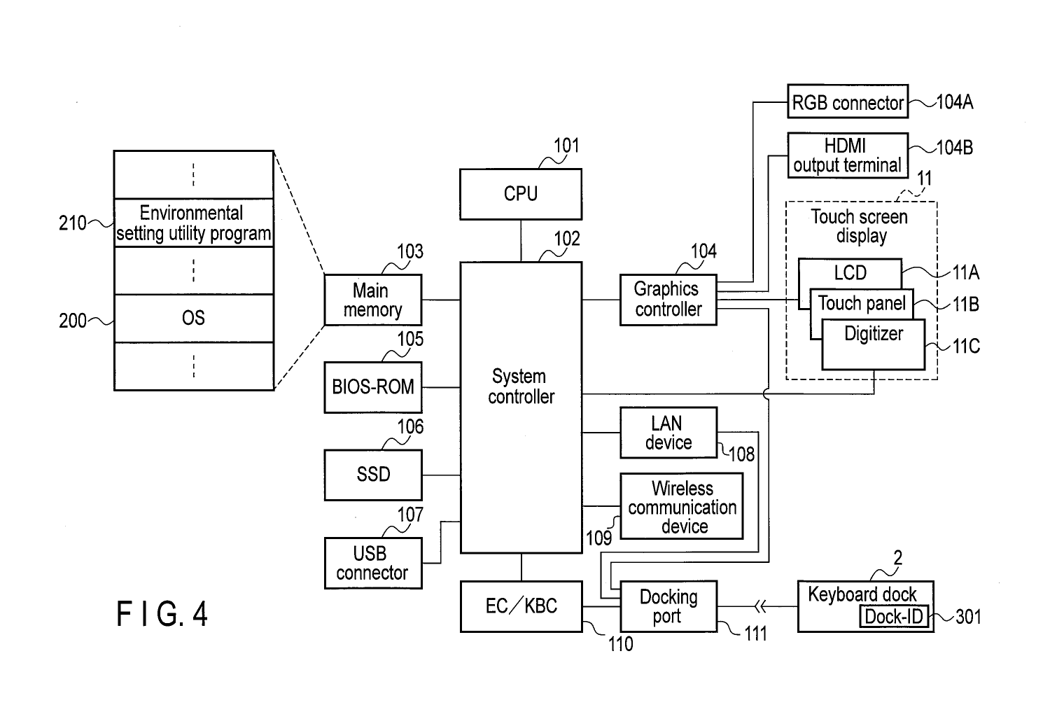

FIG. 4 is an exemplary block diagram showing a system configuration of the tablet computer 1.

As shown in FIG. 4, the tablet computer 1 includes a CPU 101, a system controller 102, a main memory 103, a graphics controller 104, an RGB connector 104A, a high-definition multimedia interface (HDMI) (trademark) output terminal 104B, a BIOS-ROM 105, a solid state drive (SSD) 106, a USB connector 107, a LAN device 108, a wireless communication device 109, an embedded controller/keyboard controller (EC/KBC) 110, a docking port 111, etc.

The CPU 101 is a processor configured to control the operation of each module in the tablet computer 1. The CPU 101 loads various programs from the SSD 106 into the main memory 103, and executes them. The programs executed by the CPU 101 include, for example, an operating system (OS) 200, and an environmental setting utility program 210 executed under the control of the OS 200.

The CPU 101 also executes a basic input/output system (BIOS) (hereinafter referred to as a “BIOS 250”) stored in the BIOS-ROM 105. The BIOS 250 is a program for control the hardware.

The system controller 102 is a device for connecting the local bus of the CPU 101 to various components. The system controller 102 contains a memory controller for controlling access to the main memory 103, and a serial ATA controller for controlling access to the SSD 106. Further, the system controller 102 also includes a function of performing communication between the graphics controller 104 and the EC/KBC 110 via, for example, a serial bus.

The graphics controller 104 is a display controller for controlling an LCD 11A used as the display monitor of the tablet computer 1. The graphics controller 104 generates display signals (LVDS signals) to be supplied to the LCD 11A, based on display data output from various programs. The graphics controller 104 can also generate analog RGB signals and HDMI video signals from the display data. The analog RGB signals are supplied to an external display via the RGB connector 104A, and the HDMI video signals are supplied to the external display via the HDMI output terminal 104B. The HDMI output terminal 104B can output both the HDMI video signals (non-compressed digital video signals) and digital audio signals, using one cable. The graphics controller 104 can also output the analog RGB signals and the HDMI video signals to the keyboard dock 2 via the docking port 111. The docking port 111 is used to electrically connect the tablet computer 1 to the keyboard dock 2.

The LCD 11A displays a screen image based on display signals supplied from the graphics controller 104. A tough panel 11B as a first sensor for detecting the touch position of a finger on the screen is provided as the upper layer of the LCD 11A. Further, a digitizer 11C as a second sensor for detecting the touch position of a pen on the screen is provided as the lower layer of the LCD 11A. The touch panel 11B is an electrostatic capacitance type pointing device, and is configured to detect the touch position of a finger on the screen and the movement of the touch position. The digitizer 11C is an electromagnetic induction type pointing device, and is configured to detect the touch position of a pen on the screen and the movement of the touch position.

The USB connector 107 is used to connect a USB device, such as a USB memory. The LAN device 108 is a device for performing wired communication based on, for example, IEEE 802.3. The connection of the tablet computer 1 to the LAN is performed by connecting a LAN cable to a LAN connector provided on the keyboard dock 2 side connected to the docking port 111. The wireless communication device 109 is a device for performing wireless communication based on, for example, IEEE 802.11g.

The EC/KBC 110 is a power management controller for performing power management of the tablet computer 1, and includes a function of powering on and off the tablet computer 1 in accordance with the operation of a power switch by a user. The EC/KBC 110 contains a keyboard controller for controlling the keyboard installed in the keyboard dock 2 connected to the docking port 111. Dock-ID 301 is stored in a nonvolatile memory installed in the keyboard dock 2 for identifying the keyboard dock 2.

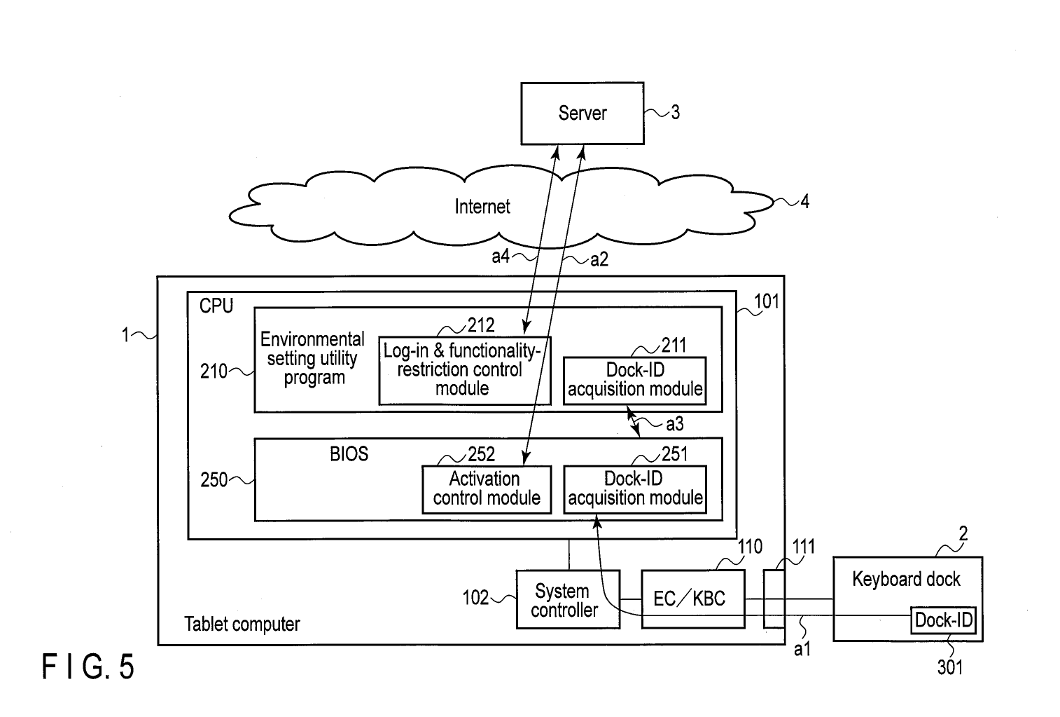

Referring now to FIG. 5, a description will be given of the basic principle of the operation of the tablet computer 1 constructed as the above, which is associated with the environmental setting or functionality restriction.

Assume here that the tablet computer 1 is powered on in a state in which the keyboard dock 2 is connected to the docking port 111. When the tablet computer 1 has been powered on, the BIOS 250 performs Power on Self Test (POST). The BIOS 250 diagnoses each component of the tablet computer 1 and initializes it by the POST. Within the POST, the BIOS 250 recognizes that the keyboard dock 2 is connected, and acquires the Dock-ID 301 from the keyboard dock 2 (a1 of FIG. 5). A Dock-ID acquisition module 251 incorporated in the BIOS 250 shown in FIG. 5 is one routine in the POST for acquiring the Dock-ID 301 from the keyboard dock 2.

Upon acquiring the Dock-ID 301 from the keyboard dock 2, the BIOS 250 transmits the Dock-ID 301 to a server 3 via, for example, the Internet 4 (a2 of FIG. 5). The transmission of the Dock-ID 301 to the server 3 is performed by an activation control module 252. The communication with the server 3 may be performed by wired communication via the LAN device 108, or by wireless communication via the wireless communication device 109. After transmitting the Dock-ID 301 to the server 3, the activation control module 252 waits for transmission, from the server 3, of activation allowance/inhibition information indicating allowance or inhibition of the activation of the tablet computer 1.

Upon receiving the activation allowance/inhibition information from the server 3, the activation control module 252 checks whether the activation allowance/inhibition information indicates inhibition of the activation of the tablet computer 1. If it indicates the inhibition of the activation, the activation control module 252 instructs the EC/KBC 110 to power off the tablet computer 1. In contrast, if it indicates the allowance of the activation, the activation control module 252 performs nothing, whereby the tablet computer 1 makes the shift to the activation procedure of the OS 200.

Namely, firstly, the tablet computer 1 can control allowance/inhibition of activation in accordance with the connected keyboard dock 2. For instance, the use, in an ultra-book style, of the tablet computer 1 allotted to a company member can be limited within the office. More specifically, the keyboard dock 2 enables necessary processing (such as processing of utilizing an external device connectable only via the keyboard dock 2) to be performed only within the office.

Assume here that the activation allowance/inhibition information indicating allowance of the activation of the tablet computer 1 has been transmitted from the server 3. In this case, the tablet computer 1 activates the OS 200. Upon activation of the OS 200, in the tablet computer 1, the environmental setting utility program 210 is activated under the control of the OS 200.

Upon being activated, the environmental setting utility program 210 firstly acquires the Dock-ID 301 of the keyboard dock 2 from the BIOS 250 (a3 of FIG. 5). The acquisition of the Dock-ID 301 from the BIOS 250 is executed by a Dock-ID acquisition module 211. If the keyboard dock 2 is not connected, the environmental setting utility program 210 recognizes that the keyboard dock 2 is not connected, based on a response from the BIOS 250 to the request for the acquisition of the Dock-ID 301 by the Dock-ID acquisition module 211.

Upon acquiring the Dock-ID 301 from the BIOS 250, the environmental setting utility program 210 transmits the Dock-ID 301 to the server 3 (a4 of FIG. 5). The transmission of the Dock-ID 301 to the server 3 is performed by a log-in & functionality-restriction control module 212. The communication with the server 3 may also be performed by wired communication using the LAN device 108, or by wireless communication using the wireless communication device 109. After transmitting the Dock-ID 301 to the server 3, the log-in & functionality-restriction control module 212 waits for receiving, from the server 3, a profile used for logging into the OS 200, and policy information associated with the functionality restriction of the tablet computer 1.

Upon receiving the profile and the policy information from the server 3, the log-in & functionality-restriction control module 212 performs logging into the OS 200 based on the profile. For instance, simply by connecting the tablet computer 1 to the keyboard dock 2 that is connected to the LAN of the office, network setting suitable for the LAN is performed, whereby the user does not have to make any network setting. Further, the layout on the desk top, as the basic screen of the OS 200, can be changed between the time when the tablet computer is connected to the keyboard dock 2 located in the user's house, and the time when the tablet computer is connected to the keyboard dock 2 located in the office.

Furthermore, when logging into the OS 200, it is determined based on the profile from the server 3 whether local logging into the OS 200 or domain logging into the OS 200 is performed. At this time, the profile existing in the tablet computer 1 may be used, and only information indicating whether local log-in or domain log-in should be performed may be received from the server 3. Also in this case, by managing information on the server 3 so that local logging into the OS 200 is made when the tablet computer is connected to the keyboard dock 2 located in the user's house, and domain logging into the OS 200 is made when the tablet computer is connected to the keyboard dock 2 located in the office, logging for, for example, receiving assignment of each information item managed by the domain controller of the office LAN becomes possible only when the tablet computer 1 is connected to the keyboard dock 2 connected to the office LAN.

Also, the log-in & functionality-restriction control module 212 restricts the functionality of the tablet computer 1 based on policy information. For instance, inhibition of printer output, inhibition of file output to a USB memory connected to the USB connector 107, etc., are performed. The restriction of the functionality of the tablet computer 1 can be realized by, for example, updating a registry file in which the OS 200 manages setting information associated with various device drivers. More specifically, it is possible to set such that printout of a document file in the tablet computer 1 is allowed when the tablet computer 1 is connected to the keyboard dock 2 placed in the office, while printout of this file is inhibited when the tablet computer 1 is connected to the keyboard dock 2 placed in the user's house.

Namely, secondly, the tablet computer 1 can perform the environmental setting and functionality restriction in accordance with the connected keyboard dock 2.

Although the embodiment describes that two-step processing of (a) controlling allowance or inhibition of activation, and (b) performing environmental setting and functionality restriction is carried out in this order in accordance with the connected keyboard dock 2, only one of the two steps may be carried out. In the case of carrying out only the former step (a), the environmental setting utility program 210 becomes unnecessary. In the case of carrying out only the latter step (b), it is sufficient if the BIOS 250 only acquires the Dock-ID 301 of the keyboard dock 2, using the Dock-ID acquisition module 251 (namely, the activation control module 252 becomes unnecessary).

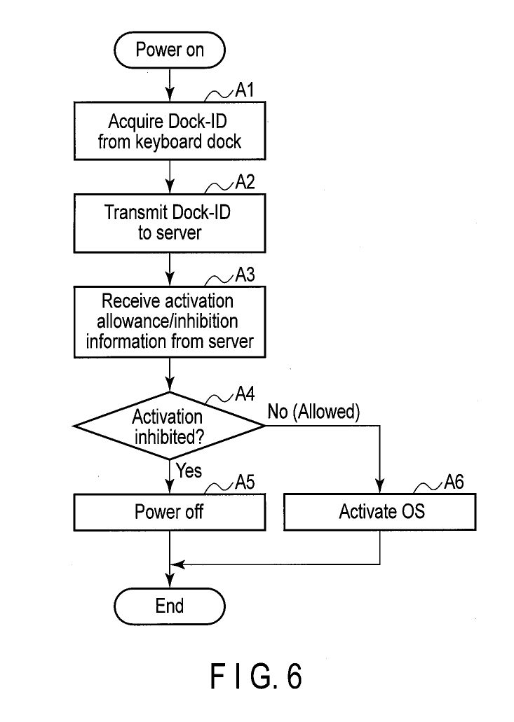

FIG. 6 is an exemplary first flowchart showing a flow of operation of the tablet computer 1 associated with the environmental setting and functionality restriction corresponding to situations.

When the tablet computer 1 (connected to the keyboard dock 2) has been powered on, the Dock-ID acquisition module 251 of the BIOS 250 acquires the Dock-ID 301 from the keyboard dock 2 (block A1). The activation control module 252 of the BIOS 250 supplies the server 3 with the Dock-ID 301 acquired by the Dock-ID acquisition module 251 (block A2), and receives the activation allowance/inhibition information returned from the server 3 in response to the transmission of the Dock-ID 301 (block A3).

If the activation allowance/inhibition information indicates inhibition of the activation of the tablet computer 1 (Yes in block A4), the activation control module 252 instructs the EC/KBC 110 to power off the tablet computer 1 (block A5). In contrast, if the activation allowance/inhibition information indicates allowance of the activation (No in block A4), the activation control module 252 does not instruct the EC/KBC 110 to power off the tablet computer 1, but activates the OS 200 (block A6).

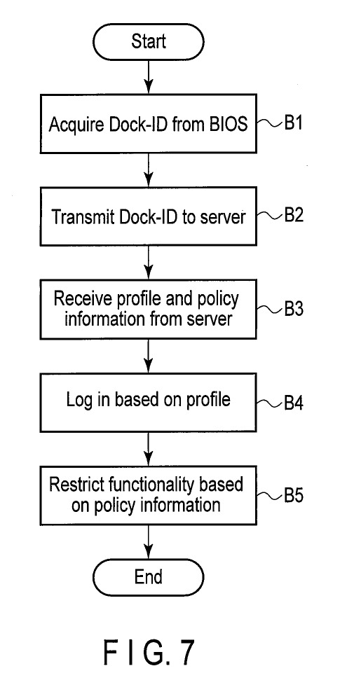

FIG. 7 is an exemplary second flowchart showing a flow of operation of the tablet computer 1 associated with the environmental setting and functionality restriction corresponding to situations.

Upon activation of the OS 200, the environmental setting utility program 210 is activated under the control of the OS 200. At this time, firstly, the Dock-ID acquisition module 211 of the environmental setting utility program 210 acquires the Dock-ID 301 of the keyboard dock 2 from the BIOS 250 (block B1). The log-in & functionality-restriction control module 212 of the environmental setting utility program 210 transmits, to the server 3, the Dock-ID 301 acquired by the Dock-ID acquisition module 211 (block B2). The log-in & functionality-restriction control module 212 receives the profile and policy information returned from the server 3 in response to the transmission of the Dock-ID 301 (block B3).

The log-in & functionality-restriction control module 212 logs into the OS 200 (block B4) based on the profile received from the server 3, and restricts the functionality of the tablet computer 1 based on the policy information received from the server 3 (block B5).

As described above, the tablet computer 1 can be adaptively controlled in environmental setting and functionality restriction in accordance with its status, more specifically, depending upon which keyboard dock 2 the tablet computer 1 is connected to.

Although the description is directed to the case where the Dock-ID 301 acquired from the keyboard dock 2 is transmitted to the server 3, and the activation allowance/inhibition information, profile and policy information are received from the server 3, this structure may be modified such that a database, which stores activation allowance/inhibition information on all keyboard docks 2 available to the user, the profile and the policy information, is installed in the tablet computer 1 to enable the activation allowance/inhibition information, the profile and the policy information to be acquired using the Dock-ID 301 as a key. Further, this database may be regularly updated by downloading its newest content from the server 3.

In addition, although the embodiment is directed to the case where different keyboard docks 2 are placed in an office and a user's house so that the environmental setting and/or functionality restriction of the tablet computer 1 is changed between the time when it is connected to the keyboard dock 2 placed in the office and the time when it is connected to the keyboard dock 2 placed in the user's house, this structure may be modified such that the environmental setting and functionality restriction of the tablet computer 1 is changed between the time when it is connected to the keyboard dock 2 placed in a personal space within an office, such as on a desk belonging to a company member, and the time when it is connected to the keyboard dock 2 placed in a shared space in the office, such as a conference room.

Since each process in the embodiment can be realized by a computer program, the same advantage as that of the embodiment can be realized simply by executing a computer program read from a computer-readable storage medium to a standard computer.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a port configured to connect to an extension unit comprising a keyboard;
an acquisition controller configured to acquire first information from the extension unit connected to the port; and
a controller configured to control an operation of the device based on the first information acquired by the acquisition controller.

2. The device of claim 1, wherein the controller is configured to allow or inhibit activation of the device based on the first information.

3. The device of claim 1, wherein the controller is configured to execute environmental setting for the device based on the first information.

4. The device of claim 1, wherein the controller is configured to restrict functionality of the device based on the first information.

5. The device of claim 1, wherein the acquisition controller comprises a part of a basic input/output system (BIOS), and is configured to acquire the first information in a power on self test (POST) configured to be executed when the device is powered on.

6. The device of claim 2, wherein the controller is configured to transmit the first information to a server connected via a network, and to receive information indicative of allowance or inhibition of the activation of the device from the server.

7. The device of claim 3, wherein the controller is configured to transmit the first information to a server connected via a network, to receive a profile for an operating system that operates on the device from the server, and to execute log-in processing for logging into the operating system based on the received profile.

8. The device of claim 3, wherein the controller is configured to make local or domain logging into the operating system operating on the device based on the first information.

9. The device of claim 4, wherein the controller is configured to transmit the first information to a server connected via a network, to receive policy information associated with functionality of the electronic device from the server, and to restrict the functionality of the electronic device based on the received policy information.

10. A control method for an electronic device comprising a port configured to connect to an extension unit comprising a keyboard, the method comprising:
acquiring first information from the extension unit connected to the port; and
controlling an operation of the device based on the acquired first information.

11. The method of claim 10, wherein the controlling comprises allowing or inhibiting activation of the device based on the first information.

12. The method of claim 10, wherein the controlling comprises performing environmental setting for the device based on the first information.

13. The method of claim 10, wherein the controlling comprises restricting functionality of the device based on the first information.

14. A computer-readable, non-transitory storage medium having stored thereon a computer program which is executable by a computer comprising a port configured to connect to an extension unit comprising a keyboard, the computer program controlling the computer to function as:
an acquisition controller configured to acquire first information from the extension unit connected to the port; and
a controller configured to control an operation of the computer based on the first information acquired by the acquisition controller.

15. The medium of claim 14, wherein the controller is configured to allow or inhibit activation of the computer based on the first information.

16. The medium of claim 14, wherein the controller is configured to execute environmental setting for the computer based on the first information.

17. The medium of claim 14, wherein the controller is configured to restrict functionality of the computer based on the first information.
